(19) United States
(12) Patent Application Publication
(10) Pub. No.: US 2004/0088547 A1
(43) Pub. Date: May 6, 2004

(54) Method and apparatus to secure online transactions over the phone

(76) Inventor: Vincent Cedric Colnot, Milpitas, CA (US)

Correspondence Address: OHVA, INC, 803 KEVENAIRE DR., MILPITAS, CA, 95035, US

(21) Appl. No.: 10/696,652

(22) Filed: Oct. 30, 2003

Related U.S. Application Data
(60) Provisional application No. 60/423,399, filed on Nov. 4, 2002.
(60) Provisional application No. 60/423,447, filed on Nov. 4, 2002.

(51) Int. Cl. H04L 9/00

(52) U.S. Cl. 713/168

(57) ABSTRACT

A method and apparatus to secure online transactions over the phone comprising a smart card transmitting an identification sequence to an IVR server in the form of a modulated signal, a card reader plugged into the telephone line, and an IVR applet demodulating the identification sequence. The card reader is characterized by the absence of processing means.

### CROSS REFERENCE TO RELATED APPLICATIONS

This application claims the benefit of the following filing date of the provisional patents No. 60/423,399, and Ser. No. 60/423,447 filed on Nov. 4, 2002.

### TECHNICAL FIELD

The present invention relates to a method to secure online transactions over the phone, and the apparatus implementing the method.

### BACKGROUND OF THE INVENTION

Integrated circuit cards, commonly referred to as smart cards, are widely used in stores to secure electronic payments.

Smart cards have not been adopted by the online market, although they provide the best security to conduct electronic commerce. The main reasons are the high cost of the card reader and the complexity of the system for most people. Not only a card but also a reader must be provided to the millions of potential end-users who comprise this market base.

The object of the present invention is to provide an inexpensive and easy to use smart card system to secure online transactions over the phone. The smart card authenticates the user when managing bank accounts, making payments, or eventually voting online, for example.

### SUMMARY OF THE INVENTION

The above object has been achieved by a smart card transmitting an identification sequence to an IVR (Interactive Voice Response) server by means of a card reader plugged into the telephone line. The reader is actually a simple and inexpensive connector without processing means. The smart card remains compliant with the ISO 7816 standards and can be used in the existing card readers.

### BRIEF DESCRIPTION OF THE DRAWINGS

FIG. 1 illustrates the method according to the present invention.

FIG. 2 is a schematic of the reader powered by the telephone line.

### DETAILED DESCRIPTION

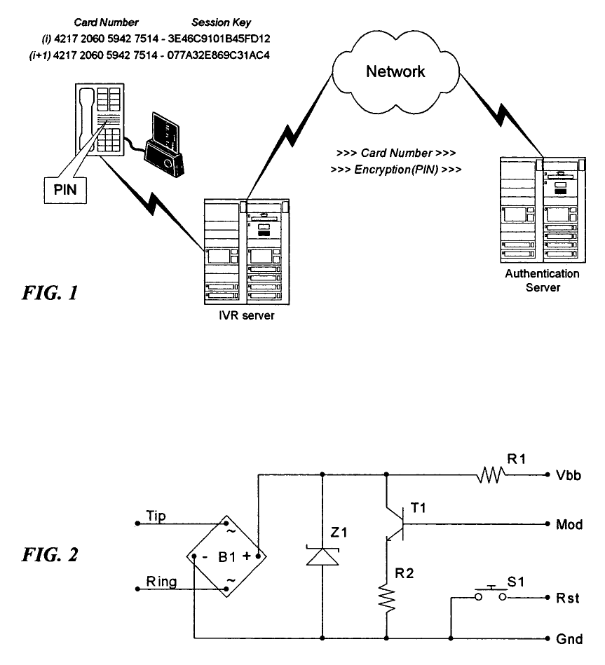

The method, as detailed in FIG. 1, carries out the user authentication over the phone. The apparatus comprises a smart card with a modulation output, a card reader plugged into the telephone line, and an IVR applet. A telephone handset is also plugged on the telephone line to establish the communication with the IVR server. The user inserts his card in the reader and enters his PIN on the telephone keypad.

When activated in the card reader, the smart card transmits an identification sequence to the IVR in the form of a modulated signal, which is demodulated by the IVR applet. The identification sequence comprises an 8-byte card number and an 8-byte random number valid only once. The card number is unique and identifies the card issuer, application version and user account. The random number is a session key (Ki) which is a function of the previous one (Ki−1) emitted by the card such as: Ki=G(Ki−1), G is a one-way function also known by the authentication server.

The session key (Ki) is used by the IVR applet to encrypt the PIN entered by the user, using the DES algorithm for instance. The encryption code is transmitted to the authentication server along with the card number, allowing the server to retrieve the previous session key (Ki−1) and the PIN stored in the authentication server database.

The authentication server deduces from (Ki−1) the session key used by the card, and decrypts the encryption code to retrieve the user PIN. The authentication is valid only if the decrypted PIN and the PIN stored in the database are identical, which means the IVR and the authentication server have used the same session key (Ki) to encrypt the PIN and decrypt the encryption code. If this is the case, the authentication server replaces (Ki−1) by (Ki) in the database. The session key (Ki) cannot be reused, even though the session key (Ki) has not been transmitted to the authentication server.

In a preferred embodiment, the smart card comprises a secure memory device with a modulation output (Mod) using a FSK (Frequency Shift Keying) modulation, for instance. The modulation frequency is in the range of 300 Hz to 3 kHz compatible with the telephone network. The modulation output (Mod) is activated only when the device is powered by the secondary power pad (Vbb) and the reset input (Rst) is pulled down.

When the smart card is used in a standard ISO 7816 reader, the secure memory device is powered by the main power pad (Vcc) disabling the modulation output (Mod). The ISO reader provides the clock (Scl) and communicates with the device using a bidirectional terminal (Sda).

The secure memory device is connected to the ISO contacts as followed:

| | |
|---|---|
| C1 = Vcc | C5 = Gnd |
| C2 = Rst | C6 = Mod |
| C3 = Scl | C7 = Sda |
| C4 = Vbb | C8 = Gnd |

The modulated signal is transmitted to the IVR via a card reader, as detailed in FIG. 2, plugged into the telephone line (Tip/Ring). Only four ISO contacts (C2, C6, C4, and C8) are required to activate the smart card.

When off-hook, the telephone line provides through the rectifier bridge B1 approximately a +10 V DC voltage. The Zener diode Z1 regulates the DC voltage between +3 V and +5 V to power (Vcc) the card and the resistor R1 limits the current drained from the telephone line. The transistor T1 and the resistor R2 realize a voltage/current conversion between the device and the telephone line. When pressed, the switch S1 pulls down the reset input (Rst) activating the modulation output (Mod).

The reader could be further integrated into the telephone handset.

1: A method and apparatus to secure online transactions over the phone comprising:
a smart card transmitting a identification sequence to an IVR server in the form of a modulated signal,
a card reader plugged into the telephone line,
an IVR applet demodulating the identification sequence,
and characterized by the absence of processing means within the card reader.

2: A method as in claim 1, wherein the identification sequence comprises at least a unique card number and a random number valid only once.

3: A method as in claim 2, wherein the random number is a session key (Ki) which is not transmitted to the authentication server.

4: A method as in claim 3, wherein the session key (Ki) is a function of the previous one (Ki−1) emitted by the card such as: Ki=G(Ki−1), G is a one-way function also known by the authentication server.

5: A method as in claim 4, wherein the session key (Ki) is used by the IVR applet to encrypt the PIN entered by the user; said encryption code is transmitted to the authentication server along with the card number.

6: A method as in claim 5, wherein the authentication server decrypts the encryption code to retrieve the user PIN, using a session key deduced from the previous one (Ki−1) stored in the authentication server database.

7: A method as in claim 6, wherein the authentication is valid only if the decrypted PIN and the PIN stored in the database are identical; if this is the case, the authentication server replaces (Ki−1) by (Ki) in the database and (Ki) cannot be reused.

8: An apparatus as in claim 1, wherein the smart card is powered by the voltage provided by the telephone line.

9: An apparatus as in claim 8, wherein the smart card transmits the modulated signal when the switch of the card reader is pressed by the user.

10: An apparatus as in claim 9, wherein the smart card transmits the modulated signal to the telephone line through the ISO contact C6.

11: An apparatus as in claim 10, wherein the smart card transmits the modulated signal when the ISO contact C2 is pulled down.

12: An apparatus as in claim 11, wherein the smart card is powered through the ISO contacts C4 and C8.

13: An apparatus as in claim 1, wherein the card reader is further integrated into the telephone handset.
